(19) United States
(12) Patent Application Publication
(10) Pub. No.: US 2018/0204556 A1
(43) Pub. Date: Jul. 19, 2018

(54) PICKUP AND STRINGED INSTRUMENT WITH PICKUP

(71) Applicant: Ichiro Katayama, Nakatsugawa-shi (JP)

(72) Inventor: Ichiro Katayama, Nakatsugawa-shi (JP)

(21) Appl. No.: 15/920,348

(22) Filed: Mar. 13, 2018

Related U.S. Application Data
(63) Continuation of application No. PCT/JP2015/076006, filed on Sep. 14, 2015.

(51) Int. Cl. G10H 3/14; G10H 3/18; G10H 1/32

(52) U.S. Cl. CPC G10H 3/143; G10D 1/08; G10H 1/32; G10H 3/18

(57) ABSTRACT

A pickup according to a present embodiment is used for a stringed instrument and converts a vibration of a string into an electric signal. The pickup includes a piezoelectric sensor that includes at least one piezoelectric element that is provided corresponding to the number of strings, a first electrode arranged on a string side of the piezoelectric element, and a second electrode arranged on an opposite side of the first electrode, a wiring electrically connected to the piezoelectric sensor, a protection part covering a portion where the piezoelectric sensor comes in contact with the string, and a cap that is formed integrally with the protection part, and comprises an arm part locked to the stringed instrument together with the string.

### CROSS-REFERENCE TO RELATED APPLICATION

This application is a Continuation Application of PCT Application No. PCT/JP2015/76006, filed Sep. 14, 2015, the entire contents of which are incorporated herein by reference.

### FIELD

Embodiments described herein relate generally to a pickup that converts a sound generated from a stringed instrument such as a guitar into an electrical signal, and a stringed instrument with such pickup.

### BACKGROUND

Conventionally, as a method of amplifying a sound generated by a stringed instrument, a method using a pickup comprising a piezoelectric element is known. This pickup converts a string vibration into an electric signal.

For example, as an installation method of the pickup, a method of installing the pickup at a bottom of a groove that holds a saddle provided on a bridge of the stringed instrument is known. In this manner, the string vibration propagated via the saddle can be detected at the piezoelectric element of the pickup (Jpn. Pat. Appln. KOKAI Publication No. 2004-177818).

However, since the pickup is installed in a space closed by a saddle, a sound detected by this pickup would not only include a lot of noise and inner reverberant sound, but would also be strongly influenced by a vibration sound of a string itself and a tone accompanying the quality of a material of the saddle supporting it; therefore, would be different from a tone generated by a vibration of air caused by an instrument's outer shell vibration that a person would actually hear with their ears.

Therefore, the object of the present invention is to provide an easily attachable pickup that can detect a sound close to an actual sound that is heard by vibrating the air around an instrument, and an instrument with such pickup.

### BRIEF DESCRIPTION OF THE DRAWINGS

FIG. 1 is a schematic view showing an acoustic guitar comprising a pickup according to a first embodiment.

FIG. 2 is a plan view showing the pickup of FIG. 1.

FIG. 3 is a partial cross-sectional view showing a state in which the pickup of FIG. 2 is partially sectioned at F3-F3.

FIG. 4 is a partially enlarged cross-sectional view in which a portion F4 in FIG. 3 is enlarged.

FIG. 5 is a plan view showing a bridge to which the pickup according to the present embodiment is attached.

FIG. 6 is a cross-sectional schematic view of an essential part of the acoustic guitar to which the pickup according to the present embodiment is attached.

FIG. 7 is a cross-sectional schematic view of an essential part of the acoustic guitar showing another attachment example of the pickup of FIG. 3.

FIG. 8 is a perspective view showing the pickup to which a cap shown in FIG. 7 is attached.

FIG. 9 is a cross-sectional schematic view of an essential part of the acoustic guitar showing yet another attachment example of the pickup shown in FIG. 3.

FIG. 10 is a plan view showing a state in which the pickup of FIG. 3 is attached to a bridge of a classic guitar.

FIG. 11 is a cross-sectional schematic view of F11-F11 in FIG. 10.

### DETAILED DESCRIPTION

A pickup according to the present embodiment is used for a stringed instrument and converts a vibration of a string into an electric signal. The pickup comprises a piezoelectric sensor that comprises at least one piezoelectric element that is provided corresponding to the number of strings, a first electrode arranged on a string side of the piezoelectric element, and a second electrode arranged on an opposite side of the first electrode, a wiring electrically connected to the piezoelectric sensor, a protection part covering a portion where the piezoelectric sensor comes in contact with the string, and a cap that is formed integrally with the protection part, and comprises an arm part locked to the stringed instrument together with the string.

The stringed instrument according to the present embodiment comprises a main body, a string strung along a surface of this main body, and a pickup that includes at least one piezoelectric element that is provided corresponding to the number of strings, a first electrode arranged on a string side of the piezoelectric element, and a second electrode arranged on a main body side that is opposite to the first electrode, and that is pressed to the main body by a tensile force of the string, and converts a vibration of the string into an electric signal. The pickup is arranged in an exposed manner on a surface of the main body.

An embodiment of the present invention will be explained with reference to the drawings.

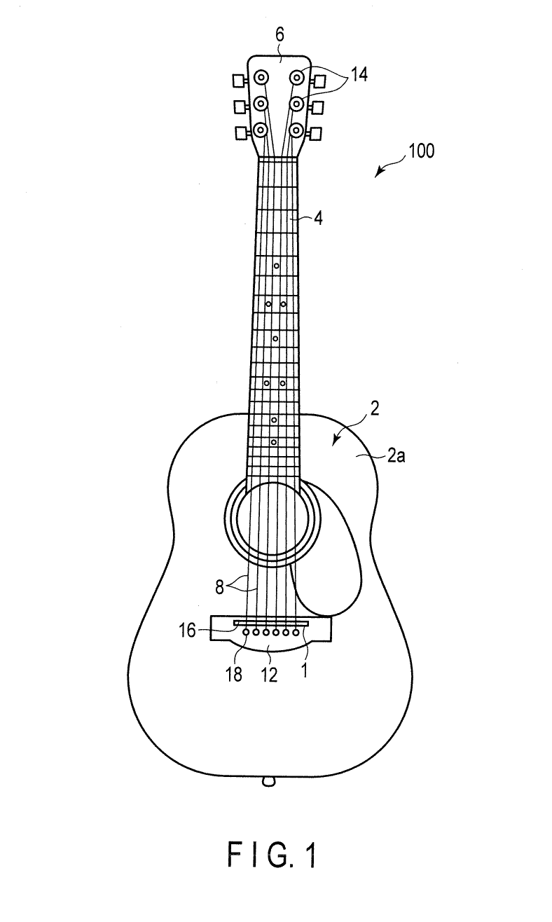

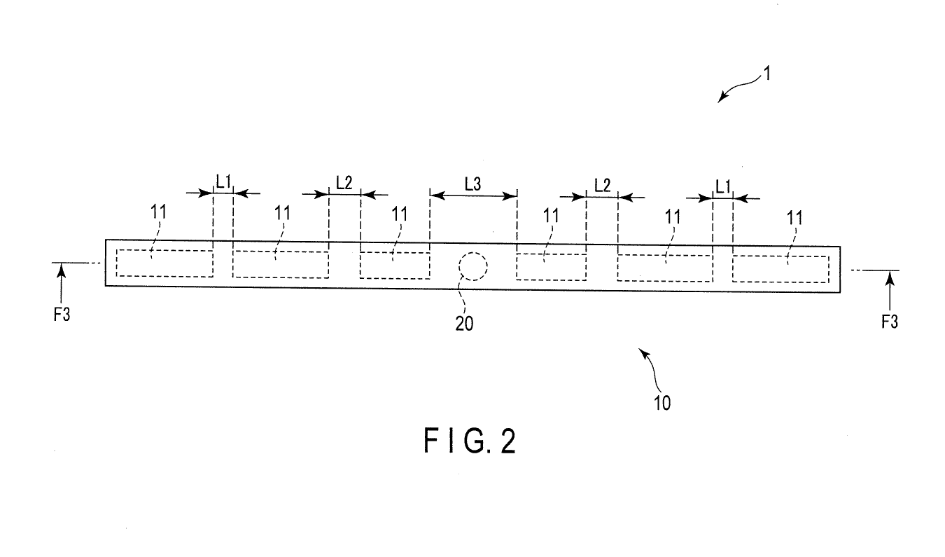

FIG. 1 is an exterior view showing an acoustic guitar 100 given as an example of a stringed instrument comprising a pickup 1 according to a first embodiment. FIG. 2 shows a plan view of the pickup 1 of the present embodiment that is attached to the acoustic guitar 100.

As shown in FIG. 1, the acoustic guitar 100 comprises a hollow main body 2 which is to be a main body of the stringed instrument, a neck 4, and a head 6. The neck 4 is a rod-like member. One end of the neck 4 is fixed to the main body 2. The other end of the neck 4 is fixed to the head 6. On a sound board 2a on a surface side of the main body 2 is provided a bridge 12 for holding one end of a string 8. On the head 6 are provided six tuning pegs 14 to which the other end of the string 8 is respectively wound. That is, the acoustic guitar 100 has six strings 8 strung along the neck 4 between the bridge 12 explained later on and the head 6.

On the bridge 12 are provided six holes 18 for fixing the string 8, a saddle 16, and the pickup 1 for converting into an electric signal a vibration caused by strumming six strings 8. The saddle 16 supports the string 8 strung along the neck 4 at a predetermined string height. That is, the saddle 16 is a supporting member that, together with the tuning peg 14, functions as a supporting point of a string vibration. The saddle 16 and the bridge 12 transmit the string vibration to the main body 2. The pickup 1 is provided between the six holes 18 and the saddle 16. The pickup 1 is arranged in an exposed manner on a surface of the bridge 12.

The pickup 1 of the present embodiment will now be explained using FIGS. 2 to 4.

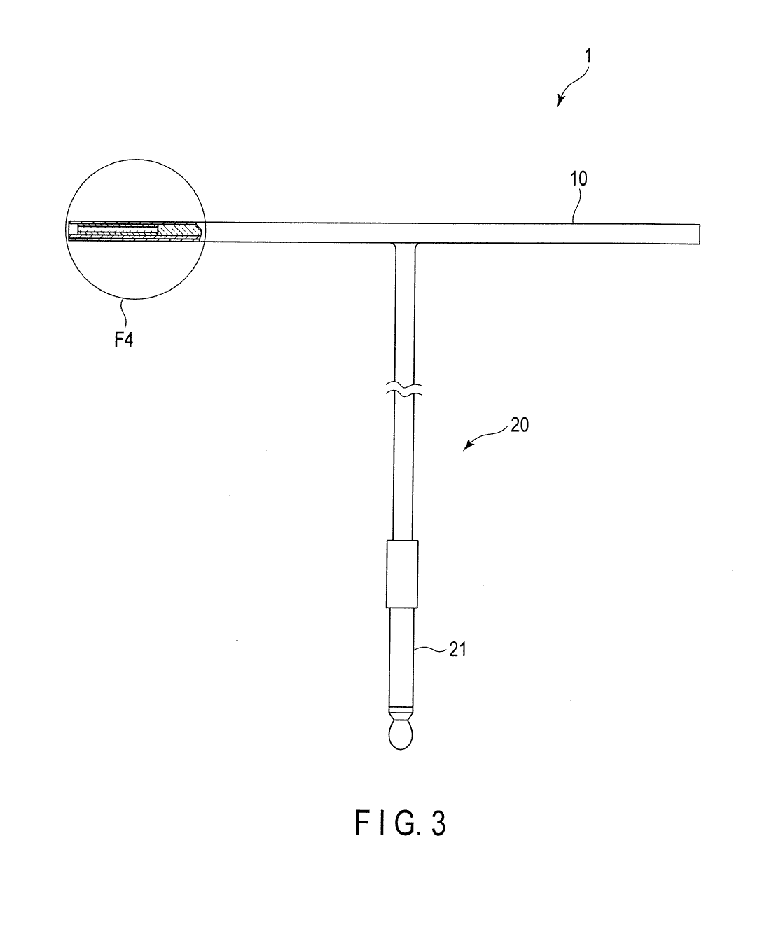

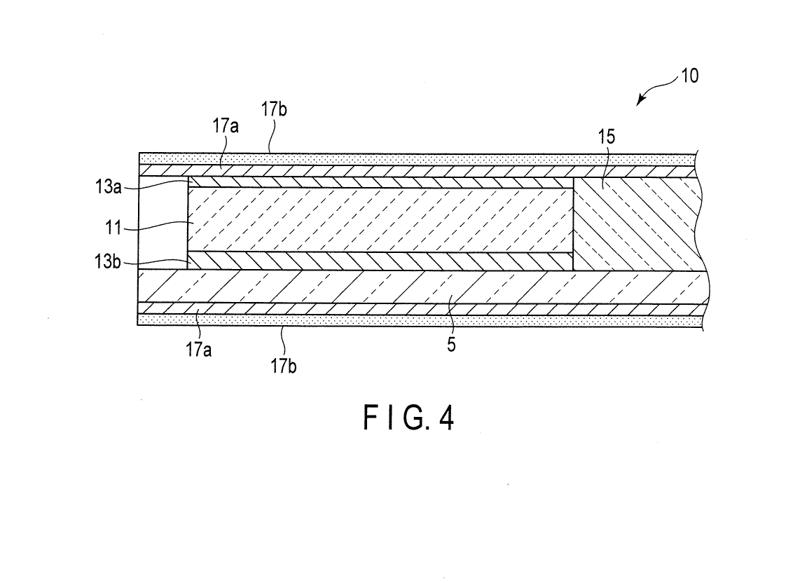

FIG. 3 is a partial cross-sectional view showing a state in which the pickup 1 shown in FIG. 2 is partially cut along F3-F3, and FIG. 4 is a partially enlarged cross-sectional view in which a portion F4 in FIG. 3 is enlarged.

As shown in FIG. 2 and FIG. 3, the pickup 1 comprises a piezoelectric sensor 10 including a plurality of piezoelectric elements 11, and a wiring 20 to transmit an electric signal acquired by the piezoelectric sensor 10. That is, on one end of the wiring 20 the piezoelectric sensor 10 is connected, and on the other end thereof a connection terminal 21 is provided.

As shown in FIG. 4, the piezoelectric sensor 10 comprises the piezoelectric element 11, a first electrode 13a, a second electrode 13b, a base 5, an intermediary member 15, a first covering material 17a, and a second covering material 17b. At a position facing the six strings 8, the piezoelectric elements 11 are arranged spaced apart from each other along a longitudinal direction of the piezoelectric sensor 10, and are aligned approximately linearly at predetermined intervals. The intermediary member 15 is a member with insulating properties that is provided between each piezoelectric element 11 of a plurality of neighboring piezoelectric elements 11 aligned on the base 5. The first electrode 13a is accumulated on each of the piezoelectric elements 11, and is positioned on the string 8 side when the piezoelectric sensor 10 is attached to the main body 2. The second electrode 13b is provided on an opposite side of the first electrode 13a via the piezoelectric element 11. In other words, the first electrode 13a is provided on one end of the piezoelectric element 11 in a direction of polarization. The second electrode 13b is provided on the other end of the piezoelectric element 11 in the direction of polarization. The base 5 is formed of a glass fiber, etc. and configures the structure of the piezoelectric sensor 10. The first covering material 17a is a conductive tape that winds and fastens the piezoelectric elements 11, the first electrode 13a, the second electrode 13b, the intermediary member 15, and the base 5 from outside. The second covering material 17b is a leather tape that further covers the first covering material 17a. As the piezoelectric element 11, for example, a lead zirconium titanate, a barium titanate, a lead titanate, and a crystal, etc. can be used. Furthermore, as the first covering material 17a, a conductive metal, such as gold, silver, copper, or an alloy thereof, that is processed thinly and tape-like can be used. Furthermore, as the second covering material 17b, animal leather and artificial leather can be used. In the present embodiments, cattle leather that has been formed tape-like is used.

The arrangement of a plurality of piezoelectric elements 11 provided on the piezoelectric sensor 10 will now be explained.

The piezoelectric elements 11 are arranged at predetermined intervals along the longitudinal direction of the piezoelectric sensor 10. According to the present embodiment, as shown in FIG. 2, six piezoelectric elements 11 are arranged at intervals.

Here, the number of piezoelectric elements 11 is provided corresponding to the number of strings 8. That is, in an acoustic guitar 100 with six strings 8, the pickup 1 comprising six piezoelectric elements 11 is used.

Furthermore, in the present embodiment, when comparing the piezoelectric elements 11, the piezoelectric elements 11 facing the first string, the second string, the fifth string, and the sixth string of the acoustic guitar 100 have different lengths from the piezoelectric elements 11 facing the third string and the fourth string in the longitudinal direction of the piezoelectric sensor 10. Therefore, a distance L2 between the piezoelectric elements 11 facing each of the second string and the third string is provided wider than a distance L1 between the piezoelectric elements 11 facing each of the first string and the second string. In the same manner, the distance L2 between the piezoelectric elements 11 facing each of the fourth string and the fifth string is provided wider than the distance L1 between the piezoelectric elements 11 arranged facing each of the fifth string and the sixth string. A distance L3 between the piezoelectric elements 11 arranged facing each of the third string and the fourth string is arranged to become wider than the distance between any adjacently arranged piezoelectric elements 11 mentioned above.

The piezoelectric sensor 10 of the pickup 1 that has such configuration is able to secure a wider region for the intermediary member 15 that is provided between the piezoelectric elements 11 facing each of the third string and the fourth string that comparatively easily detects noise by a resonance, etc. of the adjacent strings 8. Therefore, according to the piezoelectric sensor 10 of the present embodiment, interference of a sound oscillated from the adjacent strings 8 can be reduced, which would allow each of the piezoelectric elements 11 to selectively detect the sound of the strings 8 they each face. Furthermore, since the third string and the fourth string are arranged at the center of the main body 2, they are strongly affected by the vibration (sound). On the other hand, the vibration (sound) received by the first string, the second string, the fifth string, and the sixth string is smaller than that received by the third string and the fourth string. Therefore, in order to average the vibration (sound) level received by the piezoelectric elements 11, the piezoelectric elements 11 corresponding to the third string and the fourth string at the center portion are made smaller than the other piezoelectric elements 11. Furthermore, by making the piezoelectric elements 11 corresponding to the third string and the fourth string smaller, the influence of the vibrations at midrange that tend to cause a howling noise can be reduced.

As the intermediary member 15, for example, a glass fiber, a rubber polymer, a polyethylene, and a resin, can be used.

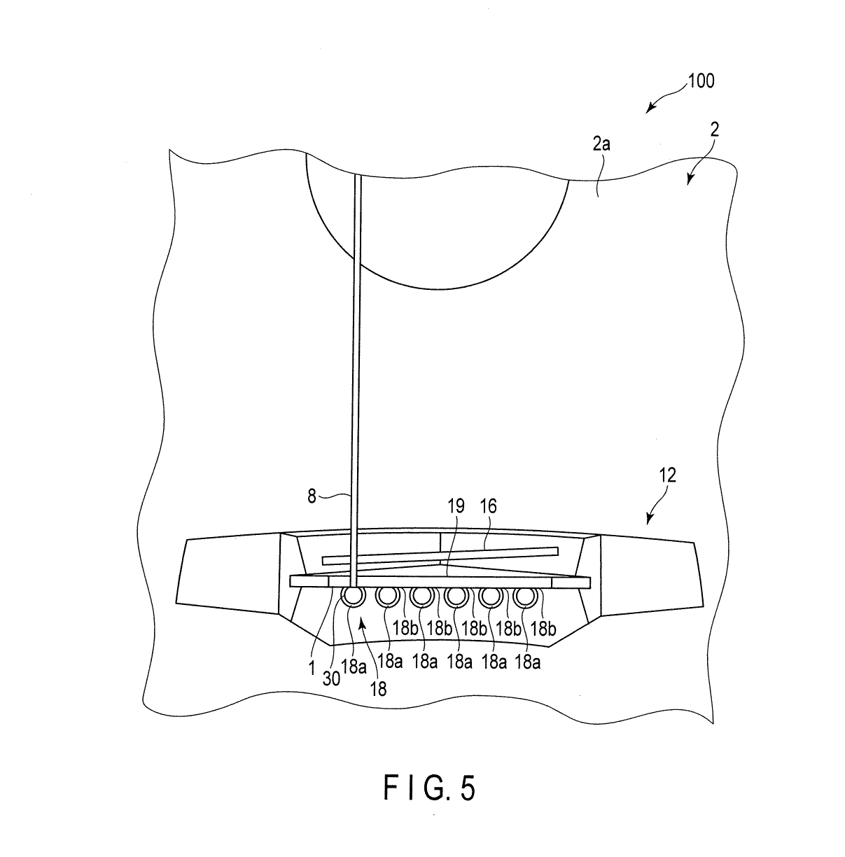

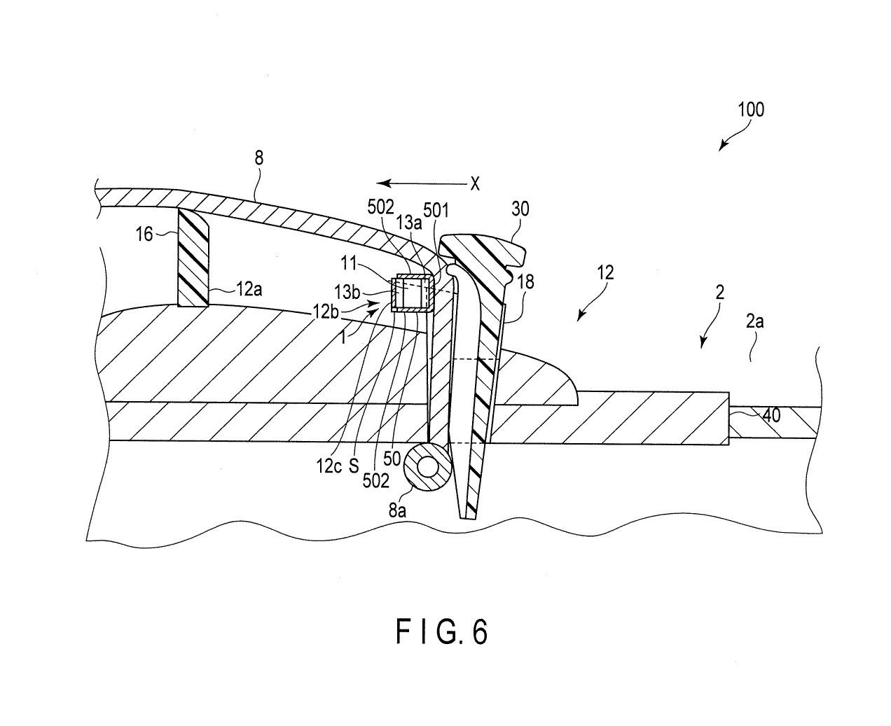

The attachment method of the pickup 1 with respect to the bridge 12 will now be explained using FIG. 5 and FIG. 6. FIG. 5 is a plan view showing the bridge 12 to which the pickup 1 is attached. FIG. 6 is a cross-sectional schematic view of the acoustic guitar 100 to which the pickup 1 is attached. In FIG. 5, only the sixth string is illustrated, and the illustrations of the first string to the fifth string are omitted.

As shown in FIG. 5 and FIG. 6, on the sound board 2a of the guitar 100, the bridge 12, the saddle 16, the string 8, a pin 30 for fixing the string 8, and the pickup 1 are provided. The bridge 12 comprises six holes 18 through which an end of the string 8 is inserted, a saddle groove 12a in which the saddle 16 is provided, and a guide groove 12b in which the pickup 1 is provided. The saddle groove 12a is an approximately rectangular groove into which the saddle 16 is fitted to be supported. The guide groove 12b is connected to six second holes 18b that will be described later on. The guide groove 12b is an approximately rectangular groove that is provided along an array direction of the strings 8.

The hole 18 has a so-called key hole shape. That is, in a planar view, the hole 18 is a hole in which an approximately circular first hole 18a and an approximately semi-circular second hole 18b are connected; the first hole 18a being a size through which a ball 8a provided at one end of the string 8 is insertable, and the second hole 18b being smaller than the ball 8a and into which the string 8 is fitted. In the present embodiment, the hole 18 corresponds to the number of strings 8, and is provided along an array direction of the string 8.

The saddle 16 is fitted along the saddle groove 12a. The saddle 16 supports the string 8 that is strung along the neck 4 from the hole 18 to the head 6.

The pin 30 is a tapered wedged member that is thinned towards the distal end. The pin 30 is wedged in the hole 18 through which the string 8 is inserted, and fixes the string 8 by the ball 8a serving as an anchor. That is, together with the hole 18, the pin 30 functions as a fixation part of the string 8.

As shown in FIG. 3, the pickup 1 comprises the piezoelectric sensor 10 and the wiring 20. In the present embodiment, for example, the wiring 20 of the pickup 1 is inserted inside the main body 2 from a through-hole 19 that is provided near the center of the bridge 12, and is connected to an unillustrated wiring substrate.

As for the structure of the piezoelectric sensor 10, since it is explained using FIG. 2 to FIG. 4, the detailed explanation thereof will be omitted. As shown in FIG. 6, a cap 50 is attached on the piezoelectric sensor 10 of the present embodiment. The cap 50 is a cross-sectionally U-shaped protective member that is attached on the outside of the second covering material 17b of the piezoelectric sensor 10. That is, the cap 50 integrally comprises a bottom wall part 501 and two side wall parts 502 that extend approximately vertically in the same direction from two opposite sides of the bottom wall part 501. Furthermore, a distance from the inner surface of the bottom wall part 501 to the distal end of the side wall part 502 of the cap 50 is formed shorter than a distance from a surface on the first electrode 13a side to a surface on the second electrode 13b side of the piezoelectric sensor 10.

The cap 50 is attached to a position where it covers the six piezoelectric elements 11 aligned in the longitudinal direction of the piezoelectric sensor 10 in the manner shown in FIG. 2. That is, in the present embodiment, six caps 50 are attached to the piezoelectric sensor 10 in a manner facing the six piezoelectric elements 11. As shown in FIG. 6, the cap 50 is attached to the piezoelectric sensor 10 in a manner that the bottom wall part 501 comes in contact with the surface on the first electrode 13a side of the piezoelectric sensor 10, and the two side wall parts 502 respectively come in contact with two side surfaces that join the surface on the first electrode 13a side and the surface on the second electrode 13b side of the piezoelectric sensor 10. That is, the bottom wall part 501 of the cap 50 is attached to face the surface on the first electrode 13a side of the piezoelectric sensor 10. In other words, the surface on the second electrode 13b side of the piezoelectric sensor 10 is not covered by the cap 50.

The cap 50 according to the present embodiment is prepared by bending two portions of a rectangular plate-like metallic plate. The width of the cap 50 is prepared at least wider than the string 8. The material of the cap 50 is not limited to metal. Therefore, materials other than metallic materials can be used as long as they are favorably transmissive without attenuating the vibration, and have a certain durability.

As shown in FIG. 5 and FIG. 6, the pickup 1 to which the six caps 50 are attached is attached along the guide groove 12b. Here, the piezoelectric sensor 10 is attached to the guide groove 12b in a direction in which the surface on the second electrode 13b side and a side wall 12c on the saddle 16 side of the guide groove 12b come in contact. In other words, the surface on the first electrode 13a side of the piezoelectric sensor 10 faces the string 8 via the cap 50.

When the tuning peg 14 is turned to give tension to the string 8, as shown in FIG. 6, the string 8 is pulled in the direction of arrow X. In this manner, the piezoelectric sensor 10 held by the guide groove 12b is pressed towards the side wall 12c on the head 6 side of the guide groove 12b by the tension of the string 8.

A space S is provided between the distal end of two side wall parts 502 of the cap 50 and the side wall 12c of the bridge 12. This space S is provided to press the piezoelectric elements 11. This allows the vibration of each string 8 to be transmitted effectively to each of the facing piezoelectric elements 11, allowing detection sensitivity of the vibration (sound) to be enhanced.

According to such pickup 1 with high sound detection sensitivity, and the acoustic guitar 100 on which such pickup 1 is arranged in an exposed manner on the outside of the main body 2, the influence of the vibration of the string 8 between the saddle 16 and the pin 30 where the string vibration is significantly attenuated can be suppressed to the minimum.

In a conventional pickup installation method, a pickup is held in a closed space that is surrounded by a saddle groove and a saddle. Therefore, a sound detected by the conventional pickup is a sound of the string 8 itself that is transmitted directly via the saddle 16, and a sound that is propagated in a closed space inside a bridge.

In contrast, the sound of the acoustic guitar 100 a person would actually hear is generated while temporally sustaining an instrument outer shell vibration by an outer shell of the main body 2 and a reverberating sound in an inner space of the main body 2 until the vibration transmitted from the saddle 16 and the bridge 12 to the main body 2 ends. The sound in the inner space of the main body 2 is an important element for forming a sound quality of a sound of the acoustic guitar 100 a person would actually hear. However, the sound in this inner space is not a sound that would have a particularly dominant influence with respect to a sound tone a person actually hears.

The pickup 1 according to the present embodiment is attached in an exposed manner on the surface of the sound board 2a. Therefore, the pickup 1 would hardly detect a direct vibration of the string 8 from the saddle 16. Furthermore, the pickup 1 is capable of reducing the occurrence of howling caused by the circulation of a reverberating sound in the inner space of the main body 2 when put through an electrical amplification device, such as an amplifier. Furthermore, a characteristic feature of a conventional pickup installation method, such as picking up an inner reverberant sound at midrange or a noise, can also be significantly reduced.

That is, when the pickup 1 is arranged in an exposed manner on the surface of the bridge 12, the pickup 1 detects a vibration (sound) that is resonated inside the main body 2 and transmitted to the sound board 2a and the bridge 12, and detects a minute vibration (sound) of the string 8 between the saddle 16 and the pin 30. The pickup 1 can also detect a vibration (sound) that is transmitted to the saddle 16 and the bridge 12, and an outer shell vibration (sound) of an instrument, in which the vibration of the entire instrument including the neck 4 vibrates the external air. In other words, the pickup 1 arranged in an exposed manner on the surface of the bridge 12 is capable of detecting a sound of the acoustic guitar 100 that is actually heard by a person, which is centered on a vibration of a so-called live sound. Here, a live sound is a vibration (sound) that reaches a person's ear with the air serving as a medium vibration.

That is, the difference between the installation method of the conventional pickup and the installation method of the pickup 1 is similar to the sound being apparently different when, for example, listening to a sound in a closed space inside a speaker box and listening to a sound transmitted through a space outside the speaker box. That is, a person's ear recognizes a comprehensive sound generated by an entire vibration that includes the outer shell of a speaker box that is vibrated by a sound generated not only at a speaker cone, but also inside the speaker box as the sound of a speaker.

According to the present embodiment, the piezoelectric sensor 10 of the pickup 1 is directly pressed by six strings 8 at a position of each piezoelectric element 11. Therefore, according to the present embodiment, the piezoelectric element 11 is arranged for each of the first to the sixth strings. Therefore, the difference in string vibration can be detected in accordance with the installation position of each string 8.

Furthermore, according to the present embodiment, a person playing an instrument can experience a three-dimensional sound by listening to a live sound of the acoustic guitar 100 that is actually heard, and a sound detected by the pickup 1 and amplified by an electrical amplification device. Such three-dimensional sound can only be realized when a sound quality that is heard from the electrical amplification device via the pickup 1 is a sound quality extremely similar to a live sound of the acoustic guitar 100.

Furthermore, the intermediary member 15 for providing predetermined intervals is provided between each of the adjacent piezoelectric elements 11. This suppresses a problem of detecting vibrations of other strings 8 that are adjacent to the string 8 facing one piezoelectric element 11, and reduces noise.

Furthermore, the conventional pickup is provided in a closed space between a saddle and a saddle groove. The vibration of a string is transmitted to a piezoelectric sensor via the saddle. Therefore, when the saddle is replaced or is cut to adjust the string height, pressure applied to the piezoelectric sensor would change and may cause a sound detection sensitivity to change.

In contrast, the pickup 1 according to the present embodiment is accommodated in the guide groove 12b of the bridge 12. Therefore, since the piezoelectric sensor 10 and the saddle 16 do not come in contact even in the case of replacing or cutting the saddle, there is no change in the detection sensitivity of the sound of the pickup 1.

The pickup 1 according to the present embodiment can also be attached to an acoustic guitar that is not provided with the pickup 1 afterward. That is, the acoustic guitar can be improved to the acoustic guitar 100 provided with the pickup 1 when an acoustic guitar's owner wishes to do so. In this case, without requiring a special technique, the pickup 1 of the present embodiment can be attached by a simple process of only providing the guide groove 12b on the bridge 12, and providing the through-hole 19 for passing the wiring 20 through.

Furthermore, the pickup 1 according to the present embodiment has the first covering material 17a covered by a cattle leather serving as the second covering material 17b. This allows the sound of a harmonic that causes howling and a reverberant sound to be reduced. The second covering material 17b also excels in terms of design and makes the presence of the pickup 1 attached to the main body 2 almost unrecognizable.

In the case where the harmonic is required to be cut further, it is also possible to provide a lead layer between the first covering material 17a and the second covering material 17b. The pickup 1 that is provided with the lead layer is capable of cutting the harmonic more effectively.

Furthermore, the pickup 1 according to the present embodiment is assembled by the pressing force of the main body 2 and the string 8. That is, in addition to not requiring the use of a special assembling member or a fixing agent, the pickup 1 according to the present embodiment is able to prevent a position of the pickup 1 from shifting by a string vibration, or the pickup 1 from peeling off of the main body 2.

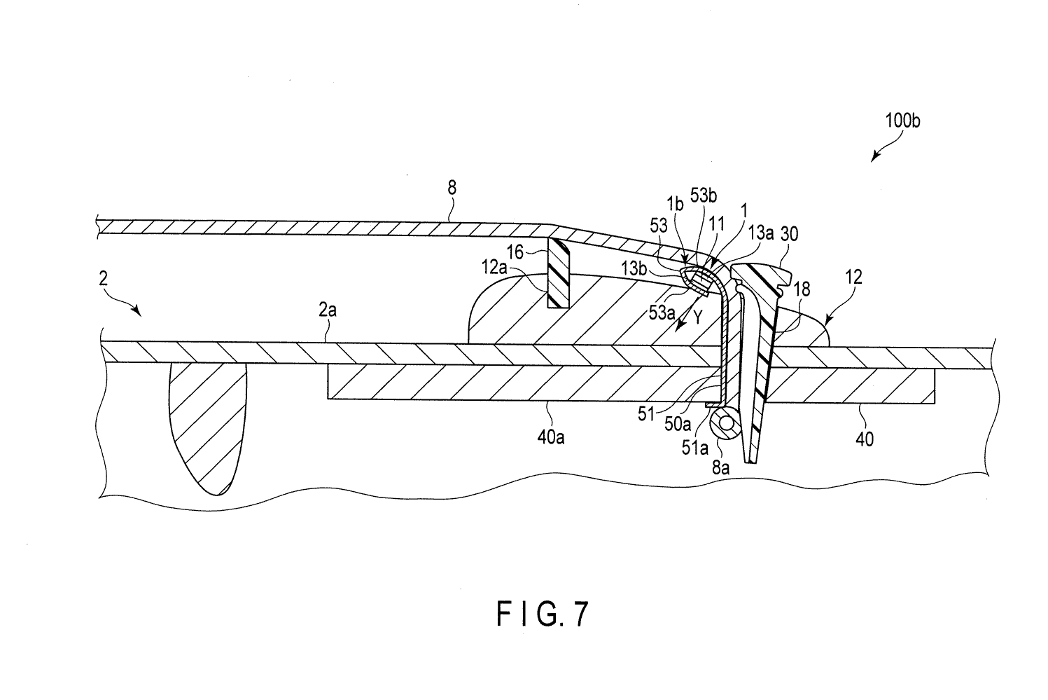

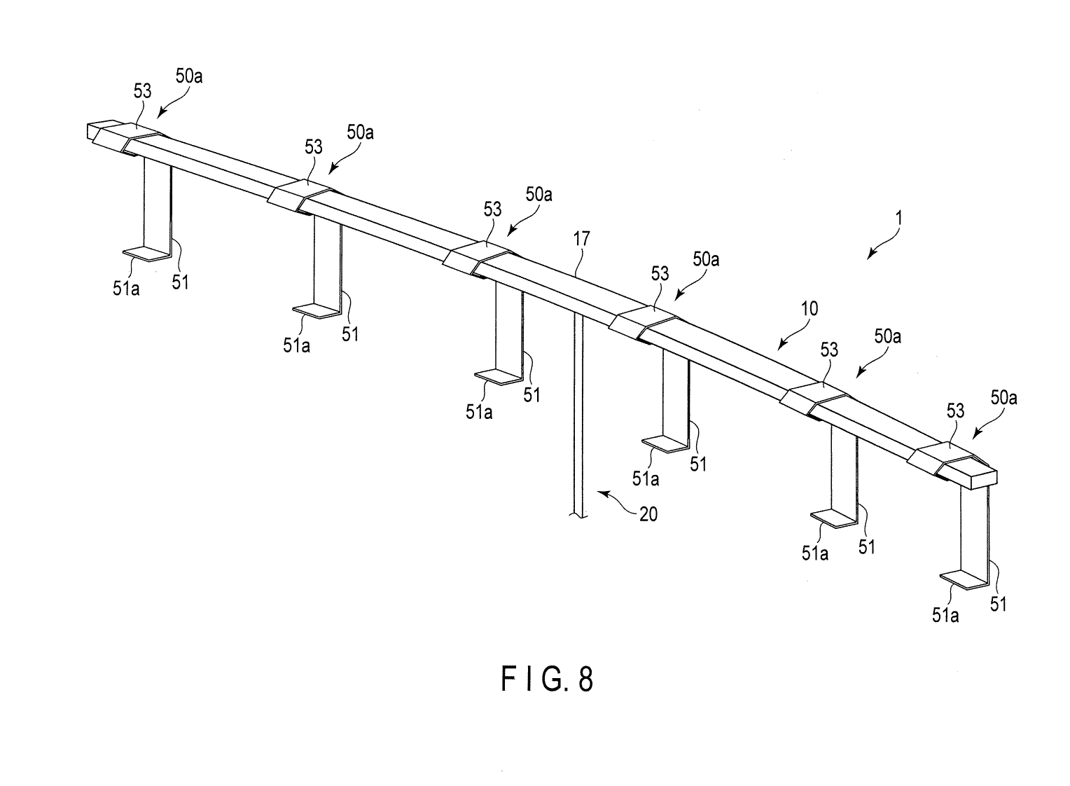

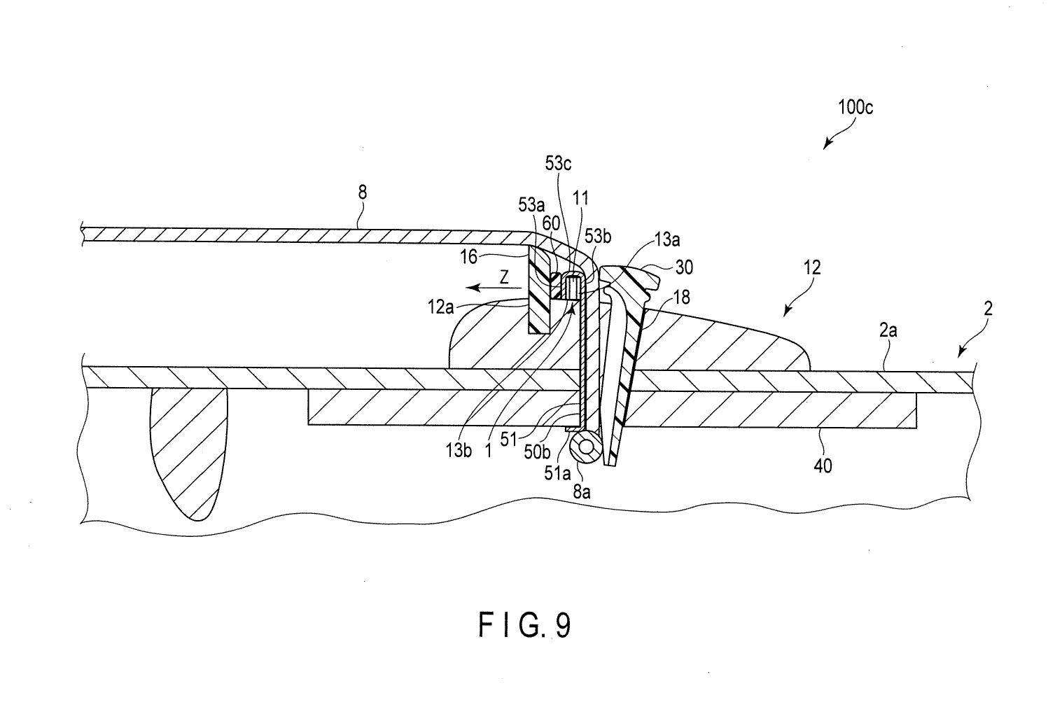

FIG. 7 to FIG. 9 will now be used to explain two modified examples of the installation method of the pickup 1. A first modified example will be explained using FIG. 7 and FIG. 8. A second modified example will be explained using FIG. 9. In the explanations of the two modified examples, constituent elements that are the same as those described in FIG. 1 to FIG. 6 will be denoted by the same symbols, and the detailed explanation thereof will be omitted.

Now, the structure of a cap 50a used in the first modified example will be explained briefly.

In the first modified example, a pickup 1 to be installed comprises a cap 50a in the manner shown in FIG. 7 and FIG. 8. FIG. 7 is a partially enlarged cross-sectional view of a partially enlarged essential part of an acoustic guitar 100b comprising the pickup 1 in which six caps 50a are attached to the piezoelectric sensor 10. FIG. 8 is a perspective view of the pickup 1 on which six caps 50a are attached.

The cap 50a shown in FIG. 7 and FIG. 8 is formed by bending a long and thin plate-like member. The cap 50a comprises an arm part 51 and a protection part 53. The protection part 53 covers the piezoelectric element 11 provided on the piezoelectric sensor 10 of the pickup 1 from outside the first covering material 17a. The protection part 53 comprises a distal end part 53a that comes in contact with the second electrode 13b side of the piezoelectric element 11, and an intermediary part 53b that comes in contact with the first electrode 13a side of the piezoelectric element 11. The protection part 53 is wound around the piezoelectric sensor 10. The protection part 53 is wound around the piezoelectric sensor 10 in a manner that the arm part 51 is positioned on a pin 30 side.

The arm part 51 comprises an engaging end 51a that is provided continuously from the intermediary part 53b of the protection part 53, and is bent in a direction away from the pin 30 on an end part on the opposite side of the intermediary part 53b. That is, the arm part 51 of the cap 50a shown in FIG. 7 is extended along a string 8 through a hole 18 from the surface of a bridge 12 to an inner side of a main body 2. The end part of the arm part 51 inserted into the main body 2 side is engaged with a surface 40a of a reinforcement plate 40 attached to the back surface of a sound board 2a. The arm part 51 is fixed together with the string 8 by the pin 30.

In the same manner as the cap 50, the cap 50a is provided in the same number as the number of piezoelectric elements 11. As shown in FIG. 8, in the present embodiment, six caps 50a are used to cover each of the piezoelectric elements 11. A more favorable workability would be realized by using the cap 50a that is bend-processed in advance of attaching the cap 50a to the piezoelectric sensor 10.

The installation of the pickup 1 in the first modified example will now be explained.

The acoustic guitar 100b shown in FIG. 7 is different from the guitar 100 shown in the embodiment of FIG. 6 in that it does not comprise a guide groove 12b for attaching the piezoelectric sensor 10 to the bridge 12. In the first modified example shown in FIG. 7, the pickup 1 is arranged between the string 8 and the bridge 12 in a state where the pickup 1 is held by the cap 50a. Here, the tension of the string 8 at a portion close to the edge on the saddle 16 side of the hole 18 acts in an arrow Y direction as a pressing force. In this manner, the pickup 1 is held in a state of being pressed against the main body 2.

In the pickup 1 comprising such cap 50a, even in the case of weakening the tension of the string 8, since the arm part 51 engages with the bridge 12 and the reinforcement plate 40, the position of the piezoelectric sensor 10 can be maintained. Therefore, the cap 50a can prevent the position of the pickup 1 from shifting.

Now, the structure of a cap 50b used in the second modified example will be explained briefly.

In the second modified example, a pickup 1 to be installed comprises the cap 50b in the manner shown in FIG. 9. FIG. 9 is a partially enlarged cross-sectional view of a partially enlarged essential part of an acoustic guitar 100c comprising the pickup 1 in which six caps 50b are attached to a piezoelectric sensor 10.

The cap 50b shown in FIG. 9 is formed by bending a long and thin plate-like member. The cap 50b comprises an arm part 51 and a protection part 53c. The protection part 53c covers a piezoelectric element 11 provided on the piezoelectric sensor 10 of the pickup 1 from outside a first covering material 17a. The protection part 53c comprises a distal end part 53a that comes in contact with a second electrode 13b side of the piezoelectric element 11, and an intermediary part 53b that comes in contact with a first electrode 13a side of the piezoelectric element 11. The protection part 53c is wound around the piezoelectric sensor 10. The protection part 53c is wound around the piezoelectric sensor 10 in a manner so that the arm part 51 is positioned on a pin 30 side.

The arm part 51 is a portion extended from the intermediary part 53b of the protection part 53c towards a lower direction of the illustration. The arm part 51 comprises an engaging end 51a that is bent in a direction away from the pin 30 on an end part on the opposite side of the intermediary part 53b. That is, the arm part 51 of the cap 50b shown in FIG. 9 is extended along a string 8 through a hole 18 from the surface of a bridge 12 to an inner side of a main body 2. The end part of the arm part 51 inserted into the main body 2 side is engaged with a surface 40a of a reinforcement plate 40 attached to the back surface of a sound board 2a. The arm part 51 is fixed together with the string 8 by the pin 30. A more favorable workability would be realized by using the cap 50b that is bend-processed in advance of attaching the cap 50b to the piezoelectric sensor 10.

The installation of the pickup 1 in the second modified example will now be explained.

The acoustic guitar 100c shown in FIG. 9 is different from the guitar 100 shown in the embodiment of FIG. 6 in that the distance between the hole 18 of the bridge 12 and a saddle 16 is close. In the second modified example shown in FIG. 9, the distance between the saddle 16 and the pickup 1 being close is utilized to hold the pickup 1 in a manner to be pressed against the saddle 16.

That is, the piezoelectric sensor 10 comprising six caps 50b is arranged between the hole 18 and the saddle 16. When the pickup 1 is arranged at this position, the tension of the string 8 acts in a direction in which the pickup 1 is pressed against the saddle 16 in the manner shown by arrow Z in FIG. 9. In other words, the piezoelectric sensor 10 is held between the saddle 16 of the main body 2 and the string 8 in a state of being pressed from the first electrode 13a side arranged on the string 8 side to the second electrode 13b side arranged on the opposite side via the piezoelectric element 11. As shown in FIG. 9, in the case where there is a space between the saddle 16 and the piezoelectric sensor 10, by sandwiching a pad called a shim 60 therebetween, the piezoelectric sensor 10 can be reliably pressed against the saddle 16.

In the above manner, according to the second modified example, in the case where the saddle 16 and the hole 18 of the bridge 12 are close, the pickup 1 can be arranged effectively. Furthermore, when the pickup 1 is attached to the position shown in FIG. 9, the pickup 1 is able to pick up a vibration from the saddle 16. Therefore, the pickup 1 according to the present modified example is able to pick up a sound that is closer to a vibration sound source and is emitted externally.

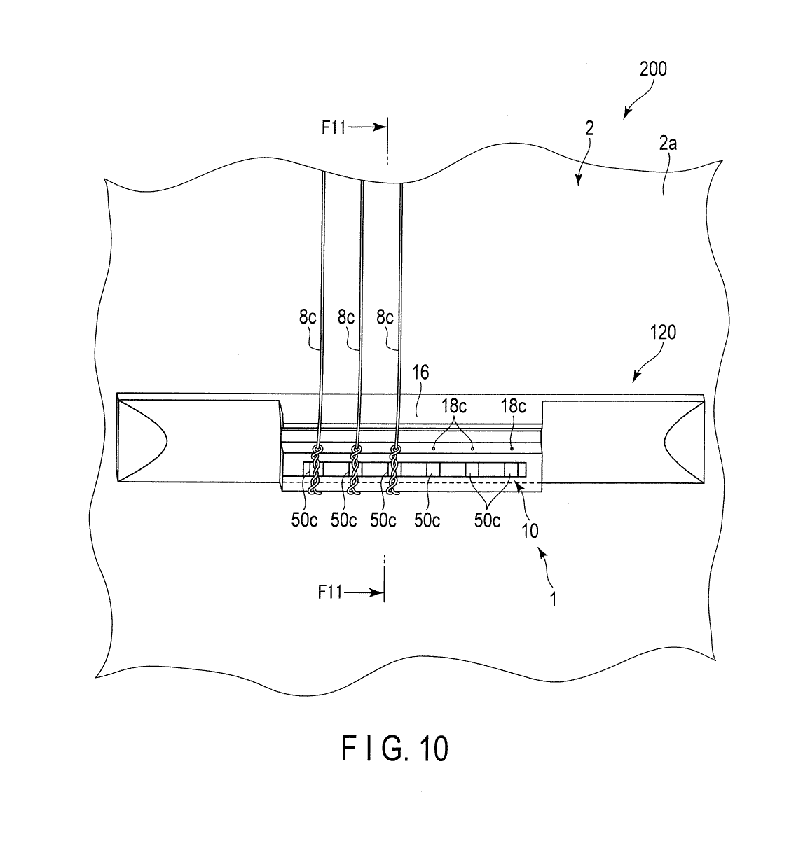

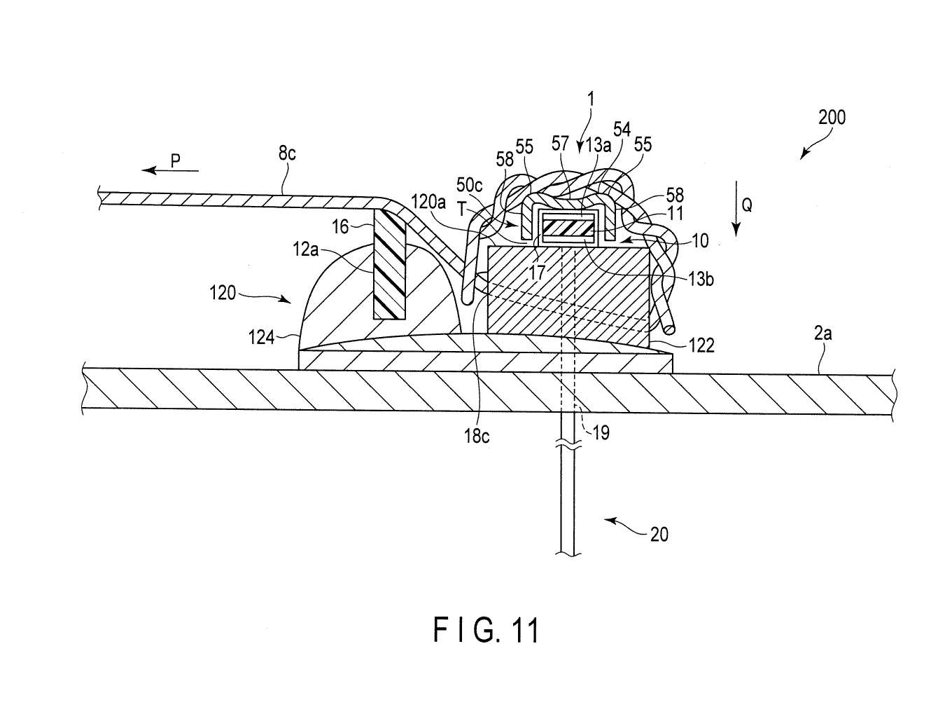

Now, a method of installing a pickup 1 on a classic guitar 200 will be explained using FIG. 10 and FIG. 11. In the explanations of the two modified examples, constituent elements that are the same as those described in FIG. 1 to FIG. 6 will be denoted by the same symbols, and the detailed explanation thereof will be omitted.

FIG. 10 is a plan view showing the classic guitar 200 comprising the pickup 1 in which six caps 50c are attached to a piezoelectric sensor 10. FIG. 11 is a cross-sectional schematic view of the classic guitar 200 shown in FIG. 10 taken along F11-F11.

As shown in FIG. 10 and FIG. 11, the classic guitar 200 comprises a bridge 120, a saddle 16, a string 8c, and a pickup 1 on a surface of a sound board 2a. The bridge 120 comprises a support pad 124 including a saddle groove 12a that supports the saddle 16, and a block-like fixing part 122 including six holes 18c to tie an end of the string 8c.

The saddle groove 12a is an approximately rectangular groove into which the saddle 16 is fitted, and which is provided at the top of the support pad 124 in a direction intersecting the string 8c in order to stably stand the saddle 16. In the present embodiment, the hole 18c corresponds to the number of strings 8c, and is provided along an array direction of the string 8c. As shown in FIG. 11, the pickup 1 is arranged in an exposed manner on a surface 120a of the fixing part 122 that fixes the saddle 16 supporting the string 8c and the end part of the string 8c.

As shown in FIG. 11, a cap 50c is attached to the piezoelectric sensor 10 of the pickup 1 of the present embodiment. The cap 50c is a cross-sectionally M-shaped protective member that is attached on the outside of a second covering material 17b of the piezoelectric sensor 10. That is, the cap 50c comprises an upper surface 54 including a concave part 57 concaving toward a center, and two side wall parts 58 that are extended approximately vertically from two facing sides of the upper surface 54. Furthermore, a space T is formed between a distal end of the side wall parts 58 of the cap 50c and the surface 120a of the bridge 120.

Now, an installation method of the pickup 1 to the bridge 120 will be explained.

The piezoelectric sensor 10 is arranged on the surface 120a of the bridge 120, and six caps 50c are arranged respectively on a portion where the six strings 8 and the piezoelectric sensor 10 come in contact. The piezoelectric sensor 10 is provided in a manner that the string 8c faces the first electrode 13a side, and the surface 120a of the bridge 120 faces the second electrode 13b side. As shown in FIG. 11, the string 8c ties the piezoelectric sensor 10 together with the bridge 120. Arrangement intervals of the six piezoelectric sensors 10 are provided in accordance with array intervals of the six strings 8c.

The cap 50c comes in contact with the first electrode 13a side of the piezoelectric sensor 10 at the inner side of the concave part 57 formed on the upper surface 54. The cap 50c is also tied by the string 8c so that it comes in contact with the string 8c at two corner parts 55 provided at both end parts of the upper surface 54.

In this state, the string 8c is pulled in the direction of arrow P. When the tension of the string 8c is increased, a force acts to depress the piezoelectric sensor 10 in an arrow Q direction by the string 8c.

Hereinafter, a force of the string 8c applied to the piezoelectric sensor 10 will be explained in detail.

The force from the string 8c acting in the arrow Q direction acts on two corner parts 55 of the cap 50c that come in contact with the string 8c. At this time, the space T is present between the distal end of the side wall parts 58 of the cap 50c and the surface 120a of the bridge 120. That is, the cap 50c is supported on a surface of the first electrode 13a side of the piezoelectric sensor 10 at the concave part 57 of the upper surface 54. Therefore, the forces acting on the two corner parts 55 are combined and act on the concave part 57. In this manner, the piezoelectric sensor 10 is supported in a state of being pressed in the arrow Q direction by the string 8c. As a result, without attenuating the vibration of the guitar main body tied by the string 8c, the cap 50c is able to transmit the vibration to the piezoelectric elements 11.

In the above manner, the pickup 1 can also be attached to the classic guitar 200 that has a different shape from the acoustic guitar 100. In the same manner as the pickup 1 attached to the acoustic guitar 100, the pickup 1 attached to the classic guitar 200 is arranged in an exposed manner on the outside of the main body 2.

Furthermore, according to such pickup 1 that has high sound detection sensitivity, and the classic guitar 200 on which this pickup 1 is arranged externally exposed on the main body 2, it is able to detect not only the string vibration directly from the saddle 16, but also the vibration (sound) resonated in the space inside the main body 2, the sound emitted from the outer shell of the main body of an instrument, and the air vibration (sound) immediately thereafter.

In a conventional pickup installation method, a pickup is held in a closed space that is surrounded by a saddle groove and a saddle. Therefore, for a sound detected by the conventional pickup, a sound of the string itself that is transmitted directly via the saddle, and a sound that is transmitted to a closed space inside a bridge serve as dominant factors.

In contrast, a sound of the classic guitar 200 a person actually hears is a sound generated by reflecting the vibration transmitted from the string 8c and the saddle 16 to the main body 2 in a space inside the main body 2, and mainly vibrating the outer shell of the main body 2 of the entire instrument to vibrate the air, which is different from a sound of a closed space inside the instrument.

Furthermore, the pickup 1 according to the present embodiment is attached in an exposed manner on the surface of the sound board 2a. Therefore, the vibration of the string 8c that is transmitted to the saddle 16 would not be detected directly. Also, since the pickup 1 is arranged in an externally exposed manner, the occurrence of howling caused by the circulation of an inner reverberating sound in the case of using an electrical amplification device, such as an amplifier, can be reduced. Furthermore, a problem in a conventional pickup installation method, such as picking up an inner reverberant sound at midrange or a noise, can also be significantly reduced.

That is, when the pickup 1 is arranged in an exposed manner on the surface 120a of the bridge 120, the pickup 1 is able to detect a vibration (sound) that is resonated inside the main body 2 and transmitted to the sound board 2a and the bridge 120, and a minute vibration (sound) of the string 8c transmitted from the saddle 16 to the bridge 120. The pickup 1 can also detect a vibration (sound) that is transmitted to the saddle 16 and the bridge 120, and an outer shell vibration (sound) of an instrument, in which the vibration of the entire instrument including the neck 4 vibrates the external air. In other words, it is possible to detect a sound of the classic guitar 200 a person actually hears, which is a vibration mainly focused on a so-called live sound.

According to the present embodiment, the piezoelectric sensor 10 of the pickup 1 is directly pressed by six strings 8c at a position of each piezoelectric element 11. Therefore, the difference in string vibration can be detected in accordance with the installation position of each string 8c.

Furthermore, according to the present embodiment, a person playing an instrument can experience a three-dimensional sound by listening to a live sound of the classic guitar 200 that is actually heard, and a sound detected by the pickup 1 and amplified by an electrical amplification device. Such three-dimensional sound can only be realized when a sound quality that is heard from the electrical amplification device via the pickup 1 is extremely similar to the sound quality of a live sound of the classic guitar 200.

Furthermore, the intermediary member 15 for providing predetermined intervals is provided between each of the adjacent piezoelectric elements 11. This suppresses a problem of detecting vibrations of other strings 8c that are adjacent to the string 8c facing one piezoelectric element 11, and reduces noise.

Furthermore, a conventional pickup is provided in a closed space between a saddle and a saddle groove. The vibration of a string is transmitted to a piezoelectric sensor via the saddle. Therefore, when the saddle is replaced or is cut to adjust the string height, pressure applied to the piezoelectric sensor would change and may cause the detection sensitivity of a sound to change.

In contrast, the pickup 1 according to the present embodiment is provided on the surface 120a of the fixing part 122 of the bridge 120. Therefore, since the piezoelectric sensor 10 and the saddle 16 do not come in contact even in the case of replacing or cutting the saddle, there is no change in the detection sensitivity of the sound of the pickup 1.

The pickup 1 according to the present embodiment can also be attached to a classic guitar that is not provided with the pickup 1 afterward. That is, the classic guitar can be improved to the classic guitar 200 provided with the pickup 1 when an owner of the classic guitar wishes to do so. In this case, the pickup 1 of the present embodiment can be attached inexpensively by a simple process of providing the piezoelectric sensor 10 on the surface 120a of the fixing part 122, and inserting the wiring 20 through the through-hole 19.

Furthermore, the pickup 1 according to the present embodiment is assembled by the pressing force of the main body 2 and the string 8c. That is, in addition to not requiring the use of a special assembling member or a fixing agent, the pickup 1 according to the present embodiment is able to prevent a position of the pickup 1 from shifting by a string vibration, or the pickup 1 from peeling off of the main body 2.

Furthermore, since the pickup 1 has a simple structure of being arranged on the surface 120a of the bridge 120, there is no need to particularly change the tension of the string 8c or the method of stringing the string 8c of the classic guitar 200. Therefore, an effect to the sound quality caused by attaching the pickup 1 is small. Furthermore, the degradation in workability of replacing the string 8c would not occur.

The above-mentioned embodiments have been presented by way of example only, and are not intended to limit the scope of the invention. Indeed, the embodiments described above may be embodied in a variety of other forms; furthermore, various omissions, substitutions, and changes may be made without departing from the spirit of the invention. The accompanying claims and their equivalents are intended to cover such forms or modifications as would fall within the scope and spirit of the invention.

For example, in the above-mentioned embodiments, a case in which the acoustic guitar 100 and the classic guitar 200 as stringed instruments are applied to the present invention has been explained; however, the stringed instruments are not limited to this. Therefore, the present invention may also be applied to other bowed stringed instruments and stringed instruments such as a violin, a cello, and a wood bass.

1. A pickup used for a stringed instrument and converting a vibration of a string into an electric signal, comprising:
a piezoelectric sensor that comprises at least one piezoelectric element that corresponds in number to the number of strings, a first electrode arranged on the string side of the piezoelectric element, and a second electrode arranged on an opposite side of the first electrode;
a wiring electrically connected to the piezoelectric sensor; and
a cap that comprises a protection part covering a portion where the piezoelectric sensor comes in contact with the string, and an arm part formed integrally with the protection part and locked to the stringed instrument with the string.

2. The pickup according to claim 1, wherein the cap comprises a first cap that faces a first piezoelectric element, a second cap that is provided separately from the first cap and faces a second piezoelectric element that is adjacent to the first piezoelectric element.

3. A stringed instrument comprising:
a main body;
a string strung along a surface of the main body; and
a pickup comprising at least one piezoelectric element provided in numbers corresponding to the number of strings, a first electrode arranged on the string side of the piezoelectric element, and a second electrode arranged on the main body side that is opposite to the first electrode, the pickup being pressed against the main body by a tensile force of the string, and converting a vibration of the string into an electric signal, wherein
the pickup is exposed on a surface of the main body, and arranged in a pressed manner against the string.

4. The stringed instrument according to claim 3, wherein the pickup is arranged between a supporting member that supports the string between the main body and the string and a fixing part that fixes an end part of the string to the main body.

5. The stringed instrument according to claim 3, wherein the pickup is arranged on a surface of a fixing part that fixes an end part of the string to the main body.

6. The stringed instrument according to claim 3, wherein the pickup further comprises a cap that protects a portion that comes in contact with the string.
